(19) United States
(12) Patent Application Publication
(10) Pub. No.: US 2026/0365276 A1
(43) Pub. Date: Nov. 19, 2026

(54) TAMPER RESISTANT UNAUTHORIZED USE ACCESS INHIBITOR FOR ELECTRIC BIKES

(71) Applicant: Also, Inc., Palo Alto, CA (US)

(72) Inventor: Nikola POPOV, Los Gatos, CA (US)

(73) Assignee: Also, Inc., Palo Alto, CA (US)

(21) Appl. No.: 19/206,810

(22) Filed: May 13, 2025

(51) Int. Cl. B62M 6/50

(52) U.S. Cl. CPC B62M 6/50

(57) ABSTRACT

A control system can include a plurality of circuits, each comprising at least one processor coupled with memory. The plurality of control circuits can include one or more circuits to provision the plurality of circuits to the electric bike using a remote computing device. The one or more circuits can activate communications over the local network with others of the plurality of circuits of the electric bike to operate the electric bike according to a first mode of operation based on the provisioning. The one or more circuits can transmit an indication of unauthorized use of the electric bike to others of the plurality of circuits in response to an identification of the unauthorized use. The one or more circuits can enter a second mode of operation in response to a receipt of the indication, and suppress the communications over the local network in the second mode of operation.

### INTRODUCTION

Vehicles can include various components in network communication with one another. Some stolen vehicles, including bicycles, can be used as a complete assembly or stripped for usable parts.

### SUMMARY

Aspects of the present disclosure relate to a control system for an electric bike. The control system can include a plurality of circuits in network communication with one-another over a local network, each of the circuits comprising at least one processor coupled with memory. The plurality of control circuits can include one or more circuits to provision the plurality of circuits to the electric bike using a remote computing device. The one or more circuits can activate communications over the local network with others of the plurality of circuits of the electric bike to operate the electric bike according to a first mode of operation based on the provisioning. The one or more circuits can transmit an indication of unauthorized use of the electric bike to others of the plurality of circuits in response to an identification of the unauthorized use. The one or more circuits can enter a second mode of operation in response to a receipt of the indication, and suppress the communications over the local network in the second mode of operation.

The one or more circuits can operatively couple pedals with a drive gear of a propulsion system in the first mode of operation. The one or more circuits can operatively decouple the pedals from the drive gear of a propulsion system of the electric bike in the second mode of operation. The one or more circuits can maintain an inventory of unique identifiers for others of the plurality of circuits. The one or more circuits can receive, from each of the others of the plurality of circuits, a unique identifier. The one or more circuits can identify the unauthorized use to enter the second mode of operation in response to detecting a mismatch between the inventory and the received unique identifiers.

The one or more circuits can receive a configurable parameter for replacement of a circuit of the plurality of circuits. The one or more circuits can receive a unique identifier for the circuit, different from another unique identifier for the circuit stored in an inventory. The one or more circuits can select between the first mode of operation and the second mode of operation based on the configurable parameter. The one or more signals can signal an indication of a location of the electric bike in the second mode of operation. The one or more circuits can engage at least one of an audible or visual alarm to signal the unauthorized use of the electric bike in the second mode of operation.

The one or more circuits can receive a configurable parameter of a geographic location. The one or more circuits can compare a location of the electric bike to the geographic location to identify the unauthorized use. The one or more circuits can enter the second mode of operation based on the comparison. The one or more circuits can receive a configurable parameter of a geographic location. The one or more circuits can compare a location of the electric bike to the geographic location to identify the unauthorized use. The one or more circuits can enter the second mode of operation based on the comparison. The one or more circuits can receive a configurable parameter for an accelerometer threshold. The one or more circuits can detect an acceleration exceeding the threshold to identify the unauthorized use.

The one or more circuits can engage a regenerative braking system to generate energy in the second mode of operation. The one or more circuits can use the energy to signal the unauthorized use of the electric bike using at least one of audible or visual signaling. The one or more circuits can receive, from the remote computing device, the identification of the unauthorized use.

Aspects of the present disclosure relate to an electric bike. The electric bike can include a propulsion system to perform regenerative braking and pedal-assist functions. The electric bike can include a plurality of circuits in network communication with one-another over a local network, each of the circuits comprising at least one processor coupled with memory. The plurality of circuits can include one or more circuits to enter a first mode of operation in response to an identification of an authorized use of the electric bike. In the first mode of operation, the one or more circuits can permit the use of the regenerative braking and pedal-assist functions, responsive to the identification of the authorized use. The one or more circuits can enter a second model of operation in response to an identification of an unauthorized use of the electric bike. In the second mode of operation, the one or more circuits can inhibit the pedal-assist function and suppress communication between the plurality of circuits over the local network.

The one or more circuits can enter a bus-off state to suppress the communications. The one or more circuits can operatively decouple pedals of the electric bike from a drive gear of the propulsion system of the electric bike. The one or more circuits can engage a regenerative braking system to generate energy. The one or more circuits can use the energy to signal the unauthorized use of the electric bike. The one or more circuits can signal the unauthorized use of the electric bike using audible or visual indicators. The one or more circuits can maintain an inventory of unique identifiers for others of the plurality of circuits. The one or more circuits can transmit, using a cellular network, an indication of the inventory and a geographic location of the electric bike in the second mode of operation.

The one or more circuits can update, responsive to a receipt of an update authorization from a remote computing device, an inventory of unique identifiers. The one or more circuits can enter the second mode of operation in response to the identification of the unauthorized use of the electric bike using the updated inventory.

Aspects of the present disclosure relate a method. The method can include provisioning an electric bike to pair the electric bike with a mobile device of an authorized user and a plurality of circuits in network communication with one-another over a local network of the electric bike. Each of the circuits can include at least one processor coupled with memory. The method an include maintaining, by one or more of the circuits, an inventory of unique identifiers for the plurality of circuits. The method can include selecting, by one or more of the circuits, between a first mode of operation and a second mode of operation based on a match between a unique identifier received from the plurality of circuits and the inventory of unique identifiers. In the first mode of operation, the propulsive operations can include pedal assist or throttle-based functions are permitted. In the second mode of operation, propulsive operations comprising pedal assist or throttle-based functions are inhibited.

The method can include identifying an unauthorized use of the electric bike based on sensor data from at least one of a location sensor or an accelerometer. The method can include transitioning from the first mode of operation to the second mode of operation based on the identification. The method can include generating, by a remote computing device, an unauthorized use flag in response to receiving an indication of theft from the mobile device. The method can include identifying an unauthorized use of the electric bike in response to a receipt of the unauthorized use flag. The method can include transitioning from the first mode of operation to the second mode of operation based on the identification. The method can include receiving, from a mobile device, a configurable parameter for a duration of a timer. The method can include transitioning from the first mode of operation to a third mode of operation in response to an expiration of the timer. The method can include transitioning from the mode of operation state to the first mode of operation in response to an authorization received by the electric bike from a user interface of the electric bike or the mobile device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram for an example of a data processing system, according to some aspects.

FIG. 2 depicts a block diagram for a data flow of the data processing system, in accordance with some aspects.

FIG. 3 depicts a state diagram for a data processing system, according to some aspects.

FIG. 4 depicts a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems to inhibit electric back access. The various concepts introduced above and discussed in greater detail below may be implemented in any of numerous ways.

The present disclosure relates to control systems for electric bikes. The control systems can include various circuits (sometimes referred to herein as modules) to perform corresponding functions. For example, the circuits can include a propulsion circuit, lighting circuit, display circuit, radio frequency (RF) communications circuit, and so forth. Each circuit can include one or more processors coupled with memory and configured to communicate with other circuits. For example, the various circuits can communicate over a controller area network (CAN) bus, among other communications devices. The control system can operate in various modes of operation. For example, the operating modes can include an operating mode in which the electric bike can be operated. The operating modes can include an operating mode in which functionality of the electric bike the electric bike is locked, but can be unlocked, such as by an entry of a PIN on a user interface, such as a user interface of a user display circuit, or as received by a communications circuit (e.g., Bluetooth, Wi-Fi, near field communications, or so forth).

The various circuits can detect an unauthorized usage of the electric bike in at least some modes of operation (e.g., in a locked mode). For example, the control systems can detect a departure from a geofenced region, a movement of the bike separate from a paired mobile device, or movement. The location of the bike can be received from a location sensor, such as a global positioning system (GPS) sensor or a proximity to a Wi-Fi signal. A movement of the bike can be detected according to an accelerometer, pedal torque sensors, wheelspin sensors, or so forth. Moreover, the control system can receive an indication of the unauthorized use from a user interface of a mobile device such as a mobile phone or other computing device. In response to an identification of the unauthorized use (e.g., theft), the control system can enter a latched-off mode of operation, sometimes referred to herein as a bricked state.

The latched-off state can be executed by various of the circuits to inhibit operation of the electric bike. For example, a propulsion unit can operatively decouple pedals from a drive gear to prevent peddling away, a friction-based or mechanical braking system can be engaged to prevent the bike from being walked away, and so forth. Moreover, according to local operations of the various circuits, their entry into the latched-off state can prevent their re-use as parts on other electric bikes. Such an operating mode is not necessarily irreversible, though reversing such a state can be accomplished according to a different procedure than transitioning from the locked operating mode to the unlocked operating mode. When in the latched-off state, the circuits can suppress at least a portion of communications with one-another over a network. For example, the various circuits can suppress a subset of messages, or enter a bus-off state. The bus-off state can include electrically or logically removing themselves from the network. The bus-off state can include inhibiting operation of other circuits on the network (e.g., shorting CAN_L to CAN_H in a CAN bus). In the latched-off state, the various circuits can signal the unauthorized condition of the electric bike. For example, a circuit coupled with lights can flash the lights, a circuit coupled with a speaker can output an alert tone (or verbal notification), a circuit coupled with a transceiver can transmit an indication of a location or a condition, and so forth.

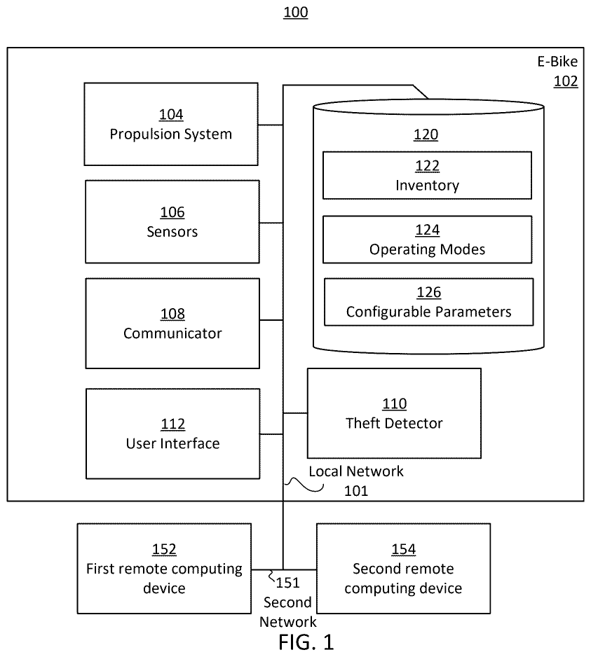

FIG. 1 is a block diagram for an example of a data processing system 100, according to some aspects. The system can include, interface with, or otherwise communicate with a control system for a vehicle, such as an electric bike (referred to as e-bike herein). The data processing system 100 can include or be part of (e.g., hosted by) the e-bike 102. The data processing system 100 can include various circuits related to functionality of the e-bike. For example, at least one of the circuits can manage, monitor, or otherwise control a propulsion system 104 of the e-bike 102. The data processing system 100 can include at least one circuit to manage, monitor, or otherwise control various sensors 106 to detect a condition (e.g., location) of the e-bike 102. The data processing system 100 can include at least one circuit to manage, monitor, or otherwise control a communicator 108, as can include a transceiver for Bluetooth, Wi-Fi, cellular connectivity, near field communication (NFC), or so forth. The data processing system 100 can include at least one circuit to manage, monitor, or otherwise control a theft detector 110 configured to detect unauthorized use of the e-bike based on, for example, sensor data received from the sensors 106 or from a user interface 112. The data processing system 100 can include or interface with at least one interface including a user interface 112, as can include an information display integral to the e-bike 102, various lights or speakers of the e-bike 102, or further devices communicatively coupled with the e-bike 102 (e.g., a mobile application of a mobile device).

The data processing system 100 can include or interface with one or more remote computing devices configured to operably couple with the e-bike 102. For example, the remote computing devices can include a first remote computing device 152 operatively coupled with the e-bike 102 via a Bluetooth, cellular, or wired connection (e.g., universal serial bus, USB). The remote computing devices can include a second computing device 154 such as a server communicatively coupled with the e-bike 102. The communicative coupling between the e-bike 102 and a remote computing device can include or omit another remote computing device. For example, a server can connect with an e-bike 102 using a cellular modem of the e-bike 102, or using a mobile device (e.g., a Bluetooth or Wi-Fi link).

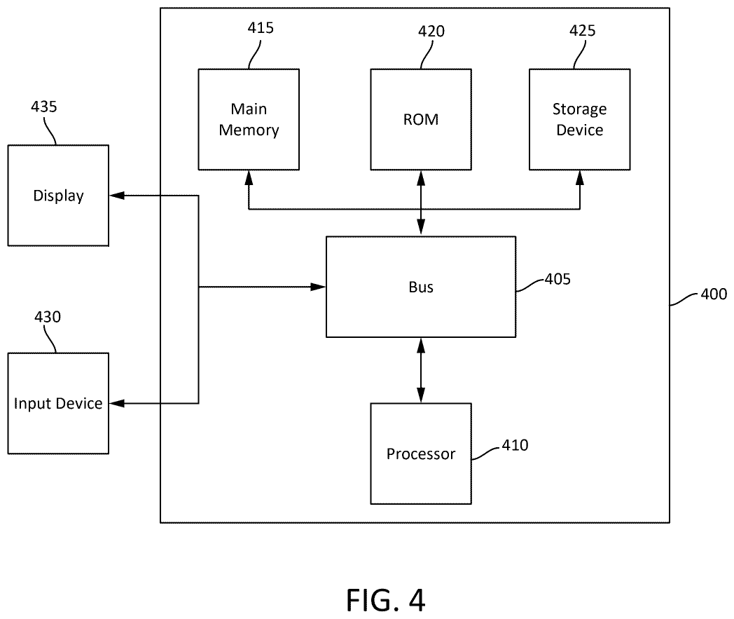

The data processing system 100 can include at least one data repository 120. The various circuits for the propulsion system 104, sensors 106, communicator 108, theft detector 110, user interface 112, and remote computing devices can each include at least one processing unit or other logic device such as programmable logic array engine, or module configured to communicate with the data repository 120 or database. The propulsion system 104, sensors 106, communicator 108, theft detector 110, and user interface 112 can be separate components, a single component, or part of the data processing system 100. The data processing system 100 can include hardware elements, such as one or more processors, logic devices, or circuits in network communication with one another. For example, the data processing system 100 can include one or more components or structures of functionality of computing devices depicted in FIG. 4.

The data repository 120 can include one or more local or distributed databases, and can include a database management system. The data repository 120 can include computer data storage or memory and can store one or more data structures, such as a data structure corresponding to an inventory 122, operating modes 124, or configurable parameters 126.

An inventory 122 can refer to or include a plurality of identifiers corresponding to components of the e-bike 102. The data structure associated with the inventory 122 can be a linked list, an array, a data table, a graph, a tree, a stack, or a queue, among other data structures to store the plurality of identifiers within the inventory 122. The identifiers can include unique identifiers. The plurality of identifiers can be at least one of serial numbers, batch numbers, part numbers, data matrix codes, radio frequency identification tags (RFID), among other forms of identifiers. For example, a first serial number within the inventory 122 can refer to a pedal assembly of the e-bike 102. In another example, a second serial number within the inventory 122 can refer to a handlebar assembly of the e-bike 102. The inventory 122 can maintain a list of the plurality of identifiers within the data repository 120 for use by the various components of the system 100. The plurality of identifiers within the inventory 122 can be used to compare identifiers received from the e-bike 102 with identifiers within the inventory 122. In this manner, the e-bike 102 (or a remote computing device) can identify or detect anomalies according to the authorization of a user of the e-bike 102.

The remote computing systems can maintain, house, or otherwise store an inventory 122 including the plurality of identifiers for each of the components of the e-bike 102 and for other e-bikes 102 associated with the system 100. For example, the remote computing systems can maintain an inventory to associate an e-bike identifier (e.g., MAC address, serial number user account number, etc.) to various components thereof, according to unique or other identifiers (e.g., serial numbers) of the components. The e-bike 102 can update all, a portion, or none of the identifiers stored in the inventory 122. For example, the e-bike 102 can update an identifier for a replaceable component, such as a battery. Such an update can be restricted according to a corresponding configurable parameter 126.

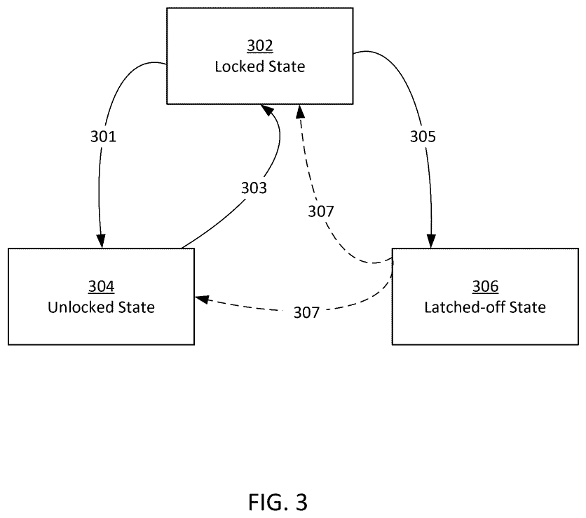

The operating modes 124 can refer to or include a plurality of modes of operation for the e-bike 102. A data structure indicating the operating modes 124 can include data table, an array, or a linked list, or a state of a finite state machine (FSM) among other data structures. The modes of operations can include locked, unlocked, latched off (e.g., responsive to a detection of theft), or recovered, among other operating modes. Each of the operating modes 124 can indicate a state of e-bike 102 as described in FIG. 3. The data processing system 100 can update the operating mode 124 based on conditions associated with the e-bike 102, such as those detected via sensors 106 of the e-bike 102 or based on data received from a remote computing device. The data processing system 100 operating modes 124 can respond to inputs from the sensors 106, the user interface 112, the propulsion system 104, and communicator 108, and provide logic for operating mode transitions based on the authorized or unauthorized use. The operating modes 124 can inhibit or permit some operations of the e-bike 102.

The configurable parameters 126 can refer to or include various indications, variables, or aspects associated with the e-bike 102. The various indications can be stored within a data structure of the data repository 120. The data structure can include at least one of a linked list, an array, a graph, a data table, bit flags, or bitfields, among others, to store indications of selected values of the configuration parameters 126.

The configurable parameters 126 can include a timer duration for a timer to transition from an unlocked or in use mode to a locked mode. The configurable parameters 126 can include a geographic location associated with one or more state transitions (e.g., to maintain an unlocked state when placed in a garage). The geographic location can refer to or include a geolocation coordinate, or other indicia of location, such as presence (or received signal strength indicator) of a Wi-Fi, Bluetooth, or other network, a presence of a key, such as a car connectivity consortium (CCC) digital key. The location can be used to manage a transition between states, such as to cause or inhibit a transition from an unlocked state to a locked state. The configurable parameters 126 can include a movement sensitivity threshold (e.g., accelerometer thresholds), or can be provided to manage other default, automatic, or approver-gated behavior. The configurable parameters 126 can store settings from the user interface 112, such as display operations of brightness selection. The configurable parameters 126 can include indications to automatically transition to a latched-off state upon a detection by the theft detector, only enter the latched-off state upon a confirmation received via the user interface 112, or so forth. The configurable parameters 126 can further include notification parameters, as can vary from state transition parameters. For example, a slight jostling of a bike or slight deviation from a geofenced religion can exceed a first threshold to cause the data processing system 100 to provide a notification to a user, but fall below a second threshold to cause the data processing system 100 to transition to a latched off state. The configurable parameters 126 can indicate adjustments for the operational parameters of e-bike 102. The data repository 120 can receive inputs from the communicator 108, the user interface 112, the remote computing devices (e.g., first remote computing device 152, second remote computing device 154) to adjust, select, or otherwise modify the configurable parameters 126.

The data processing system 100 can include or interface with one or more propulsion systems 104 to perform propulsive operations such as regenerative braking and pedal-assist functions. The propulsion system 104 can include software (e.g., computer executable instructions) and hardware (e.g., one or more processors, electric motors, batteries, controllers, or pedal-assist sensors) to provide motion to the e-bike 102. The propulsion system 104 can generate signals for pedal-assist and regenerative braking. The propulsion system 104 can include one or more circuits to manage, maintain, or otherwise control battery charging or discharging. For example, the propulsion system 104 can include a battery management circuit and a motor control circuit. The propulsion system 104 can manage, maintain, or otherwise control movements associated with the e-bike 102 using various hardware such as electric motors, pedal assist, throttle functions, among other movements. The propulsion system 104 can include pedals which are operably decouplable from other components of the propulsion system 104. For example, in a locked or latched-off state, the pedals can move freely (if a brake is not engaged) but may not cause the e-bike to move.

The propulsion system 104 can implement, trigger, or provide regenerative braking functions. The regenerative braking functions can supply electrical energy for storage within the battery or use by any of the various circuits of the e-bike 102. Upon detection of the brakes triggering within the e-bike 102, the propulsion system 104 can cause energy conversion within the e-bike 102. The energy conversion can trigger the motors of the propulsion system 104 to execute in reverse thereby performing as a generator to convert kinetic energy to electrical energy. The propulsion system 104 can store the electrical energy within the battery to extend an effective range of the e-bike 102. The propulsion system 104 can implement regenerative braking upon each trigger of the brake of the e-bike 102.

The data processing system 100 can include or interface with one or more sensors 106 to detect a condition of the e-bike 102. For example, the sensors can include one or more location sensors 106, as can include a global navigation satellite system sensor, or a proximity sensor, such as a modem or transceiver to communicate with a Wi-Fi, Bluetooth, Cellular, or other device to determine a location relative to such a device. Some sensors 106 can determine a distance from a corresponding device according to an RSSI, triangulation, cross referencing of multiple devices (e.g., multiple Wi-Fi base stations or cellular towers). The sensors 106 can include an accelerometer or wheel spin sensor to detect movement of the e-bike. The sensors 106 can pedal torque sensors to detect pedal movement, as can indicate a movement of the e-bike 102, or various sensors of other e-bike controls (e.g., brake actuation sensor 106, touchscreen sensor 106 of a display, or so forth).

The data processing system 100 can include or interface with one or more communicators 108 to manage, transmit, or otherwise receive signals from external devices (e.g., remote computing device 152/154, servers, data centers). The communicator 108 can include hardware and software to aid the system 100 to communicate with one or more external devices. The communicator 108 can generate signals that include data for transmission. For example, the communicator 108 can transmit signals via a transceiver for Bluetooth, Wi-Fi, cellular connectivity, near field communication (NFC), or so forth. The communicator 108 can implement a plurality of communication protocols (e.g., hypertext transfer protocol, transmission control protocol, simple mail transfer protocol, message querying telemetry transport, among other protocols. Using the communication protocols, the communicators 108 can transmit data related to bike operations and security events to the external devices. The communicator 108 can communicate via various networks. For example, the communicator 108 can operate as a bridge between a first network for components of the e-bike 102 with various further devices. The various further devices can include a first remote computing device 152 proximal to the device, as can include a mobile device hosting a mobile application or web browser to manage the e-bike 102. The various further devices can include a second remote computing device 154, such as a server communicatively coupled with the e-bike. The various remote computing devices can communicate with one another. For example, a mobile device can operate as a gateway to couple with the e-bike 102 (e.g., via Bluetooth or Wi-Fi with the bike and Wi-Fi or cellular with the server) or a server can operate as a gateway to couple with the e-bike 102.

The data processing system 100 can include or interface with one or more theft detectors 110 to identify, based on sensor data or information received from the user interface 112, an unauthorized use of the e-bike 102. The theft detector 110 can access or communicate with the sensors 106 to receive sensor data related to unauthorized use of the e-bike 102. The theft detector can compare information in the sensor data to various thresholds or other criterion for a detection of unauthorized use of the electric bike 102. For example, the theft detector 110 can compare a location of the e-bike 102 to a geofenced area, compare an instantaneous acceleration or movement over time to a threshold, compare a time of use to an authorized time of use, compare a number of incorrect PIN entries to a threshold, or evaluations of further criteria. The theft detector 110 can evaluate criteria incorporating multiple of the configuration parameter 126. For example, a geofence may be associated with a further time-based restriction (e.g., time of day, day of week, or so forth), or can further be associated with a proximity to a user (e.g., a time of restriction applies unless a mobile device paired with the e-bike 102 is in communication). The activation of the various thresholds or other criteria, as well as their magnitude can be adjusted according to configuration parameters 126. Further, the theft detector 110 can indicate unauthorized use based on a command received from a user interface.

The theft detector 110 can identify a non-authorized use according to a mismatch between an inventory 122 and a detected component. For example, a server can maintain an inventory 122 of unauthorized (e.g., stolen) components, as may be indicated by an unauthorized use flag in response to receiving an indication of theft (e.g., from a mobile device). Upon a detection of the mismatch, the data processing system 100 can communicate with the server to compare the mismatched part to the inventory of unauthorized (e.g., stolen) components, or can provide an indication of the identification of the mismatched component, as may aid in its recovery. If the mismatched part is not unauthorized (e.g., not reported as stolen), the data processing system 100 can execute a reprovisioning process to update the maintained inventory 122, according to an update authorization received from the server.

The reprovisioning or other update to the inventory 122 can depend on a configurable parameter 126. For example, a user who only uses a single battery can disengage functionality to operate with a replacement battery, and select a corresponding configuration parameter. A different user can use multiple batteries, and engage the functionality to operate with multiple batteries. Upon detection of the mismatched battery, the data processing system can select between a latched-off and other mode of operation based on the configuration parameter 126. For example, for the user who only has one battery, the replacement battery could indicate potential unauthorized use, while for the user who uses multiple batteries, the use can indicate using a second battery, borrowing a battery, or so forth.

The data processing system 100 can include or interface with one or more user interfaces 112 to receive user inputs or output data. The user interfaces 112 can include a display (e.g., touchscreen display) integral to or coupled with the e-bike 102 or another computing device, such as a mobile device. The user interface 112 can aid user interactions with the e-bike 102. The user interface 112 can display various information associated with the e-bike 102 such as operating modes 124, inventory 122, configurable parameters 126, among other settings. The user interface can 112 can connect and interface with the propulsion system 104, the sensors 106, the communicator 108, and the theft detector 110. For example, the user interface 112 can relay a received command to indicate non-authorized operation to the theft detector 110 to cause the theft detector 110 to provide the indication to various circuits of the e-bike. The user interface can include various lights, speakers, or other components of the e-bike 102, which can provide indications of unauthorized use in a latched-off state.

The various components of the data processing system 100 can couple, directly or indirectly, with one another via a first network 101. Examples of the first network 101 can include a CAN bus, LIN bus, Ethernet, combinations thereof, or so forth. The network 101 can include wired and wireless communications according to one or more standards and/or via one or more transport mediums. A second network 151 can couple the various components of the e-bike 102 with one or more remote computing devices. Examples of the second network 101 can include a Bluetooth, Wi-Fi, Ethernet, combinations thereof, or so forth.

The data processing system 100 can include or interface with a first remote computing device 152, such as a mobile phone or a laptop computer. The first remote computing device 152 can be any device comprising one or more processors with memory capable of transmitting data or receiving interactions via a user interface. The computing device 152 can transmit interactions with the e-bike establishing configurable parameters 126, provide authentication credentials, among other information associated with a user of the e-bike. The first remote computing device 152 can be at least one of a computer, terminal, laptop, smartphone, desktop, among others. The data processing system 100 can include a second remote computing device 154 communicatively coupled with the e-bike 102 over the second network 151, such as a server communicatively coupled with the e-bike 102. The second remote computing device 154 can be any device comprising one or more processors with memory capable of transmitting commands to the e-bike 102 or receiving alerts from the theft detector 110.

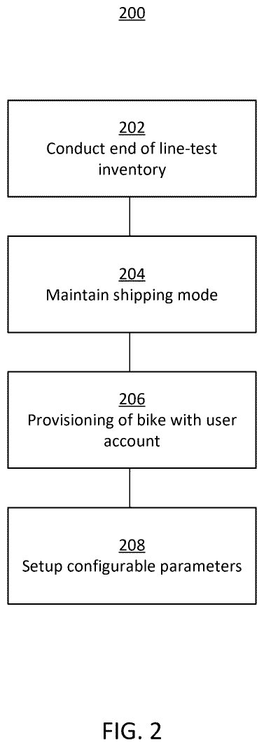

FIG. 2 depicts a block diagram 200 for a data flow of the data processing system 100, in accordance with some aspects. The data processing system 100 can execute the various ACTs of the block diagram 200. The method can be performed by one or more systems or components depicted in FIG. 1. For example, at least some ACTs can be performed by one or more circuits of the e-bike 102. Some ACTs of the data flow can be performed by a remote computing device. The various operations of the method can include ACTs provided henceforth can inherit, duplicate, or adapt various aspects described throughout the present disclosure.

At ACT 202, the data processing system 100 prepares the e-bike 102 for operation by determining an inventory 122. The data processing system 100 can use the inventory 122 of available parts and components of the e-bike 102. The data processing system 100 can provide one or more steps for assembly of the e-bike 102 based on the inventory 122 of the components for the e-bike 102 (e.g., wheels, handlebars, saddle, gears, pedal-assist, brake system, battery, motor). The data processing system 100 can store the inventory, as can be mapped to one or more further identifiers of the e-bike 102, as can aid the data processing system to map an identifier to an e-bike in use, or associated with a user account. At ACT 202, the e-bike can be placed into a test mode of operation. Such a mode of operation can be, or include aspects of functionality of, the unlocked mode.

The data processing system 100 can test, evaluate, or analyze the assembled e-bike 102 to verify that the performance satisfies a performance threshold. The performance threshold can indicate a baseline or optimal value for the performance of the e-bike 102 during testing. The testing can include communication between various circuits of the e-bike, along with battery life verification, motor function, ride quality, or responsiveness of the detection of unauthorized users, among other tests. For example, the data processing system 100 can initiate a battery test to verify that the battery of the e-bike 102 or the regenerative braking of the e-bike 102 operates nominally.

At ACT 204, the data processing system 100 prepares the e-bike 102 for shipping. The data processing system can automatically prepare the e-bike 102 for shipping upon completion of the assembly and testing of the e-bike 102. In preparation of the e-bike 102, the data processing system 100 can execute a final test or inspection on the e-bike 102, as can include storage of the inventory, or other attributes of the e-bike 102. The final test can verify one or more circuits such as the function of the propulsion system 104, the performance of the first network 101 or the second network 151. The results of the test can be stored within the data repository 120. Preparation for shipping can include transitioning from the teste mode to a shipping mode. For example, the shipping mode can disengage certain functionality to reduce battery usage in transit, enable modems to improve tracking of the e-bike in transit, prevent unauthorized use of the e-bike in transit, or permit some operations (e.g., in a demonstration mode). A state of the shipping mode can permit a transition to a user-provisioning mode.

At ACT 206, the data processing system 100 provisions the e-bike 102 with a user account for an authorized user via at least one of the first remote computing device 152 or the second remote computing device 154. The user account can be included in a data structure that is represented as a profile. The data processing system 100 can link the e-bike 102 to the user account according to a registration and provisioning process. The registration process can include an account setup (e.g., name, address, identifier of the e-bike 102, etc.), a user identify verification (e.g., Personal Identifying Number, multi-factor authentication, Face-ID, biometric fingerprint identification, passcode, etc.), and configurations for the e-bike 102. The data processing system 100 can store each of the above identified information within the data repository 120. The registration process can be initiated by the first remote computing device 152. For example, a user may input a name, address, and model of the e-bike into the first remote computing device 152. The user can further input authorization credentials (e.g., PIN, passcode, biometric fingerprint) associated with the e-bike 102. The registration or provisioning process can include provision of various configuration parameter 126 to the data processing system. For example, the configuration parameter can reflect a storage or use of the e-bike. For example, a geofence can be established to maintain the bike in a locked state responsive to a receipt of an indication that the bike will be stored in a garage or other secure area, or such a geolocation can be omitted if the user does not provide an indication of such a storage area.

Based on the registration process, the data processing system 100 can activate functionality of the e-bike 102 to operate according to one or more settings or configurations. For example, a configuration parameter 126 of the e-bike 102 can maintain the e-bike 102 in a locked operating mode 124 according to a schedule (e.g., before dawn). In another example, a configuration parameter of the e-bike 102 can maintain the e-bike 102 in an unlocked operating mode 124 on specific days of the week. In this manner, the data processing system 100 can modulate the operation of each e-bike 102 in accordance with the use and habits of the user, as received via configuration parameters 126. Upon registration, the data processing system 100 can provide communications, via the communicator 108, over the local network 101 to operate the e-bike according to a first operating mode 124 (e.g., unlocked) based on the provisioning.

In the first operating mode 124, the theft detector 110 can operatively couple pedals with a drive gear of the propulsion system 104 in the first operating mode 124. In this manner, the propulsion system 104 can use the configurable parameters 126 and user inputs at the pedals to operate the e-bike 102. The data processing system can transmit, an indication of a geographic location of the e-bike 102 in at least one operating mode 124 to the second remote computing device 154 via the second network 151.

The data processing system 100 can establish, generate, or determine a baseline for the user based on the habits and the configuration within the registration process and store the baseline in the inventory 122. The theft detector 110 can compare each use of the e-bike against the baseline to determine whether the comparison satisfies a threshold indicating the presence of suspicious activity associated with the e-bike 102. If the comparison satisfies the threshold, the theft detector 110 can generate an alert indicating suspicious activity with the e-bike 102. The communicator 108 can provide the alert to the user interface 112, the first remote computing device 152, and the second remote computing device 154. The communicator 108 can configure the alert to engage audible or visual indicators (e.g., alarms) to signal the unauthorized use of the e-bike 102 in the second operating mode 124.

As such, the communicator 108 can transmit an indication of unauthorized use of the e-bike 102 to others of the plurality of circuits (e.g., propulsion system 104, sensors 106, user interface 112, remote computing device 152/154) in response to an identification of the unauthorized use. From here, the theft detector 110 can enter a second mode of operation 124 (e.g., locked) in response to a receipt of the indication, and suppress the communications over the local network 101 until the unauthorized use is resolved. The theft detector 110 can operatively decouple the pedals from the drive gear of the propulsion system 104 of the electric bike in the second operating mode 124, thereby preventing interactions with the e-bike 102. From here, the sensors 106 can signal an indication of the location of the e-bike 102 when the e-by entered the second operating mode 124.

At ACT 208 the data processing system 100 establishes configurable parameters 126 for the e-bike 102. The configurable parameters 126 can impact, adjust, or change the operation of the e-bike 102. The configurable parameters 126 can be adjusted according to one or more inputs by the first remote computing device 152 corresponding to preference of the user within the use account at registration. For example, the one or more inputs can indicate that the e-bike 102 should be in a specific gear when the user begins to use the e-bike 102. In another example, the one or more user inputs can indicate that the e-bike 102 is to have a specific regenerative breaking strength. The theft detector 110 can receive the configurable parameter to replace a circuit of the plurality of circuits (e.g., propulsion system 104) and concurrently receive a unique identifier for the respective circuit. The unique identifier can be different from the unique identifier stored within the data repository 120. Based on the difference, the theft detector 110 can select or identify between the one or more of the operating modes 124.

The configurable parameters 126 can correspond to speed limits, regenerative braking strength, pedal-assist frequency, pedal-assist sensitivity, acceleration threshold, geographic location, among other parameters impacting the operation of the e-bike. The one or more user inputs can be stored within the data repository 120 for implementation by the e-bike 102. For example, the theft detector 110 can compare the location of the e-bike 102 to the geographic location of the configurable parameter 126 to identify the unauthorized use and enter the second operating mode 124. In another example, the theft detector 110 can detect an acceleration that exceeds the acceleration threshold, thereby indicating unauthorized use. Such an acceleration can refer to momentary acceleration, or indications of movement (e.g., dead reckoning).

The data processing system 100 can establish the configurable parameters in real time using the user interface 112. The user interface 112 can receive, retrieve, or otherwise obtain interactions from a user of the e-bike 102. The interactions can be captured or detected by the user interface 112 based on one or more selected user interface elements. For example, the user can select a user interface element that correspond to the speed limit of the e-bike. The data processing system 100 can adjust the speed limit of the e-bike in accordance with the selection. In another example, the user can adjust a timer for use of the e-bike 102 through the user interface 112. The data processing system can adjust the timer for use within the configurable parameters 126 based on the interaction. In some instances, the propulsion system 104 can engage regenerative braking to generate electrical energy while in the second operating mode 124 and can use the electrical energy to signal unauthorized use of the e-bike via an audible or visual signal.

The data processing system 100 can establish the configurable parameters 126 based on one or more environmental conditions. The environmental conditions can refer to or include fluctuating temperatures (e.g., hot and cold), humidity, rain, snow, ice, wind, altitude, dust, sand, mud, road salt, UV radiation, fog, pollution, terrain roughness, steep inclines, steep declines, water puddles, lightning, and debris. For example, the sensors 106 can detect rain impacting the e-bike 102. The propulsion system 104 can calculate or determine a speed limit to safely operate the e-bike 102 in the presence of rain. In another example, the sensors 106 can detect a steep decline impacting the e-bike 102. The propulsion system 104 can determine a sensitivity of the regenerative braking to ensure safe operation of the e-bike 102 down the steep decline.

FIG. 3 depicts a state diagram 300 for a data processing system, according to some aspects. For example, the state diagram can correspond to a finite state machine, or according to various further implementations. The states (also referred to as modes of operation, without limiting effect), include a locked state 302, an unlocked state 304, and a latched-off state 306. Each of the states can correspond to the operating modes 124.

In the state diagram 300, the e-bike 102 can be in the locked state 302. The locked state 302 can indicate restricted use of the e-bike 102. The restricted use of the e-bike 102 can cause the propulsion system 104 to not provide power to the e-bike 102. Restricted use of the e-bike 102 can include inhibiting pedal-assist, inhibiting throttle-based functions, blocking access to the user interface 112, or preventing movement of the e-bike, among other reduced functionality. In some cases, at least one component of the propulsion system 104 (e.g., the pedals) can be operatively decoupled from the e-bike 102 to prevent movement. Incident to reduced functionality, network traffic can be less frequent than in the unlocked state, but still include unsuppressed messages, relative to the latched-off state 306.

The first state transition 301 represents the transition from the locked state 302 to the unlocked state 304. The data processing system 100 can transition from the locked state 302 to the unlocked state 304 based on a verification of the authorized use of the e-bike. For example, a PIN entered into the user interface 112 can match a PIN stored within the data repository 120 (e.g., a local storage of the e-bike 102). The data processing system 100 can transition from the locked state 302 to the unlocked state 304 based on a receipt of an unlock command from a remote computing device. For example, the unlock command can be received via a mobile device proximal to the e-bike 102, or as routed through a remote server in cellular communication with the e-bike 102. Upon a completion of the first state transition, the e-bike 102 can operate in the unlocked state 304.

The unlocked state 304 can engage various functionality of the e-bike 102. For example, in the unlocked state, the user interface 112 can display information and be accessible to update configurable parameters 126. The data processing system can operatively couple pedals with a drive gear of the propulsion system 104 of the bike, and further activate pedal assist or throttle-based operation.

At a second state transition 303, the data processing system 100 can transition from the unlocked state 304 to the locked state 302. The data processing system 100 can automatically initiate the second state transition 303 based on a satisfaction of various criteria, as can vary based on selected configuration parameter 126. For example, a duration or use of a timer to lock the bike upon inactivity can depend upon a corresponding configuration parameter 126. A location or use of a geofence to lock the bike (or prevent locking) can depend upon a corresponding configuration parameter 126. Moreover, the data processing system 100 can initiate the second state transition 303 in response to a receipt of a command, as can be received from a user interface element integral to the e-bike, as a part of a control element of a mobile application of a remote computing device, or so forth.

A third state transition 305 represents a change from the locked state 302 to the latched-off state 306. The data processing system 100 can initiate the third state transition 305 based on an indication of unauthorized use received from the theft detector 110. The data processing system 100 can transition to the latched-off state responsive to a receipt of a command via a user interface 112, such as via mobile application of a remote computing device. The commanded transition can refer to the third transition 305, or a transition from another state (e.g., from the unlocked state). For example, upon a theft of the e-bike 102, a user can use a mobile application to communicate the transition command to the bike, or cause the server to transmit the command to the bike.

The latched-off state 306 can disengage certain functionality of the e-bike 102. For example, the disengaged functionality can include a suppression of communications over a network, as can include all or a portion of communications. The suppression of communications can be achieved according to a bus-off state, or otherwise. For example, one or more circuits can transmit an indication of unauthorized use of the electric bike to others of the various circuits in response to an identification of the unauthorized use. Such a state can inhibit tampering with the individual circuits, or prevent their re-use, as may reduce thefts, since neither of a functional bicycle, nor usable components can be so acquired.

In the latched off state 306, various circuits can inhibit operation of the e-bike 102, or aid in the recovery of the e-bike 102. For example, the propulsion system 104 can operatively decouple pedals from a drive gear of the electric bike 102. One or more circuits can signal an indication of a location of the electric bike 102. Such signaling can refer to radio transmission of GNSS coordinates, among other indicators, such as a flashing light, sounding of a horn, transmitting any nearby detected wireless networks, or so forth. That is, one or more circuits can provide at least one of an audible or visual alarm to signal the unauthorized use of the electric bike 102. Actions of the various circuits can depend on a state of charge (SoC) of a battery, so that energy-using actions are decreased to extend a duration of emissions, at least where a circuit has access to SoC information. Prior or subsequent to a depletion of a battery, the data processing system can engage a regenerative braking system to generate energy in the latched-off state 306. For example, the data processing system can use the energy to signal the unauthorized use of the electric bike using audible or visual signaling, or RF transmissions.

The e-bike 102 can remain in the latched-off state 306 permanently, or until a reset or reauthorization procedure is preformed, as indicated by the fourth state transition 307. Such a transition can be performed according to different criteria than for transitions between the locked state 302 and unlocked state 304. For example, at least one module (e.g., all modules) can include instructions to return to a locked, unlocked, shipping, or other state upon a command as can be provided via wired or wireless communications, such as via one or more debug or service ports (e.g., serial, JTAG, USB, etc.).

FIG. 4 depicts an example block diagram of an example computer system 400. The computer system or computing device 400 can include or be used to implement a data processing system 100 or its components. The computing system 400 includes at least one bus 405 or other communication component for communicating information and at least one processor 410 or processing circuit coupled to the bus 405 for processing information. The computing system 400 can also include one or more processors 410 or processing circuits coupled to the bus for processing information. The computing system 400 also includes at least one main memory 415, such as a random-access memory (RAM) or other dynamic storage device, coupled to the bus 405 for storing information, and instructions to be executed by the processor 410. The main memory 415 can be used for storing information during execution of instructions by the processor 410. The computing system 400 may further include at least one read only memory (ROM) 420 or other static storage device coupled to the bus 405 for storing static information and instructions for the processor 410. A storage device 425, such as a solid-state device, magnetic disk or optical disk, can be coupled to the bus 405 to persistently store information and instructions.

The computing system 400 may be coupled via the bus 405 to a display 435, such as a liquid crystal display, or active-matrix display, for displaying information to a user such as a user disposed within a cabin of an electric vehicle or exterior to the cabin. An input device 430, such as a button or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors 106 providing any value determined herein, sensors 106 providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A control system for an electric bike, comprising:
a plurality of circuits in network communication with one-another over a local network, each of the circuits comprising at least one processor coupled with memory, the plurality of circuits comprising one or more circuits to:
provision the plurality of circuits to the electric bike using a remote computing device;
activate communications over the local network with others of the plurality of circuits of the electric bike to operate the electric bike according to a first mode of operation based on the provisioning;
transmit an indication of unauthorized use of the electric bike to others of the plurality of circuits in response to an identification of the unauthorized use; and
enter a second mode of operation in response to a receipt of the indication, and suppress the communications over the local network in the second mode of operation.

2. The control system of claim 1, comprising one or more circuits of the plurality of circuits to:
operatively couple pedals with a drive gear of a propulsion system in the first mode of operation; and
operatively decouple the pedals from the drive gear of a propulsion system of the electric bike in the second mode of operation.

3. The control system of claim 1, comprising one or more of the plurality of circuits to:
maintain an inventory of unique identifiers for others of the plurality of circuits;
receive, from each of the others of the plurality of circuits, a unique identifier; and
identify the unauthorized use to enter the second mode of operation in response to detecting a mismatch between the inventory and the received unique identifiers.

4. The control system of claim 1, comprising one or more of the plurality of circuits to:
receive a configurable parameter for replacement of a circuit of the plurality of circuits;
receive a unique identifier for the circuit, different from another unique identifier for the circuit stored in an inventory; and
select between the first mode of operation and the second mode of operation based on the configurable parameter.

5. The control system of claim 1, comprising one or more circuits of the plurality of circuits to:
signal an indication of a location of the electric bike in the second mode of operation.

6. The control system of claim 1, comprising one or more circuits of the plurality of circuits to:
engage at least one of an audible or visual alarm to signal the unauthorized use of the electric bike in the second mode of operation.

7. The control system of claim 1, comprising one or more of the plurality of circuits to:
receive a configurable parameter of a geographic location;
compare a location of the electric bike to the geographic location to identify the unauthorized use; and
enter the second mode of operation based on the comparison.

8. The control system of claim 1, comprising one or more of the plurality of circuits to:
receive a configurable parameter for an accelerometer threshold; and
detect an acceleration exceeding the threshold to identify the unauthorized use.

9. The control system of claim 1, comprising one or more of the plurality of circuits to:
engage a regenerative braking system to generate energy in the second mode of operation; and
use the energy to signal the unauthorized use of the electric bike using at least one of audible or visual signaling.

10. The control system of claim 1, comprising one or more of the plurality of circuits to:
receive, from the remote computing device, the identification of the unauthorized use.

11. An electric bike, comprising:
a propulsion system to perform regenerative braking and pedal-assist functions; and
a plurality of circuits in network communication with one-another over a local network, each of the circuits comprising at least one processor coupled with memory, the plurality of circuits comprising one or more circuits to:
enter a first mode of operation in response to an identification of an authorized use of the electric bike and, in the first mode of operation:
permit the use of the regenerative braking and pedal-assist functions responsive to the identification of the authorized use; and
enter a second mode of operation in response to an identification of an unauthorized use of the electric bike and, in the second mode of operation:
inhibit the pedal-assist function; and
suppress communications between the plurality of circuits over the local network.

12. The electric bike of claim 11, comprising one or more of the plurality of circuits to enter a bus-off state to suppress the communications.

13. The electric bike of claim 11, comprising one or more of the plurality of circuits to, in the second mode of operation:
operatively decouple pedals of the electric bike from a drive gear of the propulsion system of the electric bike;
engage a regenerative braking system to generate energy; and
use the energy to signal the unauthorized use of the electric bike.

14. The electric bike of claim 11, comprising one or more of the plurality of circuits to, in the second mode of operation:
signal the unauthorized use of the electric bike using audible or visual indicators.

15. The electric bike of claim 11, comprising one or more of the plurality of circuits to:
maintain an inventory of unique identifiers for others of the plurality of circuits; and
transmit, using a cellular network, an indication of the inventory and a geographic location of the electric bike in the second mode of operation.

16. The electric bike of claim 11, comprising one or more of the plurality of circuits to:
update, responsive to a receipt of an update authorization from a remote computing device, an inventory of unique identifiers; and
enter the second mode of operation in response to the identification of the unauthorized use of the electric bike using the updated inventory.

17. A method comprising:
provisioning an electric bike to pair the electric bike with a mobile device of an authorized user and a plurality of circuits in network communication with one-another over a local network of the electric bike, each of the circuits comprising at least one processor coupled with memory;
maintaining, by one or more of the circuits, an inventory of unique identifiers for the plurality of circuits; and
selecting, by one or more of the circuits, between a first mode of operation and a second mode of operation based on a match between a unique identifier received from the plurality of circuits and the inventory of unique identifiers, wherein:
in the first mode of operation, propulsive operations comprising pedal assist or throttle-based functions are permitted; and
in the second mode of operation, propulsive operations comprising pedal assist or throttle-based functions are inhibited.

18. The method of claim 17, comprising:
identifying an unauthorized use of the electric bike based on sensor data from at least one of a location sensor or an accelerometer; and
transitioning from the first mode of operation to the second mode of operation based on the identification.

19. The method of claim 17, comprising:
generating, by a remote computing device, an unauthorized use flag in response to receiving an indication of theft from the mobile device;
identifying an unauthorized use of the electric bike in response to a receipt of the unauthorized use flag; and
transitioning from the first mode of operation to the second mode of operation based on the identification.

20. The method of claim 17, comprising:
receiving, from a mobile device, a configurable parameter for a duration of a timer;
transitioning from the first mode of operation to a third mode of operation in response to an expiration of the timer; and
transitioning from the second mode of operation to the first mode of operation in response to an authorization received by the electric bike from a user interface of the electric bike or the mobile device.
